(19) United States
(12) Patent Application Publication
(10) Pub. No.: US 2024/0056531 A1
(43) Pub. Date: Feb. 15, 2024

(54) Method for processing a request to set up a call

(71) Applicant: ORANGE, Issy-les-Moulineaux (FR)

(72) Inventors: Ahmed Ben Ali, TUNIS (TN); Houcem Houiji, TUNIS (TN); Mehdi Nagmar, TUNIS (TN)

(21) Appl. No.: 18/259,161

(22) PCT Filed: Dec. 17, 2021
(86) PCT No.: PCT/FR2021/052373

§ 371 Date: Jun. 23, 2023

(30) Foreign Application Priority Data
Dec. 24, 2020 (FR) 2014129

(51) Int. Cl. H04M 15/00

(52) U.S. Cl. CPC H04M 15/858; H04M 15/851

(57) ABSTRACT

A method for processing a request to set up a call between an originating terminal identified by at least one originating number, and a destination terminal identified by a destination number. The method is implemented in the originating terminal and includes: obtaining information relating to pricing for the call between the origin number and the destination number, referred to as pricing information; sending a confirmation request including the pricing information; and receiving a command confirming the request to set up a call.

### 1. CROSS-REFERENCE TO RELATED APPLICATIONS

This application is a Section 371 National Stage Application of International Application No. PCT/FR2021/052373, filed Dec. 17, 2021, which is incorporated by reference in its entirety and published as WO 2022/136775 A1 on Jun. 30, 2022, not in English.

### 2. FIELD OF THE INVENTION

The invention is in the field of mobile telephony.

### 3. BACKGROUND OF THE DISCLOSURE

Call termination refers to the transmission cost billed by one operator to another operator in order to make or terminate a call over their network.

When the subscriber of an operator A calls a subscriber of an operator B, the operator A must pay the operator B a call termination for each billing unit of the communication. The billing unit is one second or one minute, for example. In general, for the subscriber, the cost of an inter-operator call is greater than the cost of an intra-operator call, i.e., a call from the subscriber of the operator A to another subscriber of the operator A. Furthermore, in the case of an inter-operator call, the cost also can be different depending on the destination operator of the call.

Before initiating a call, it is therefore worthwhile for the subscriber to know the operator of the subscriber that they wish to contact.

One solution such as, for example, the mobile application “Contacts with Morocco Operator”, developed by ‘Toubkal Mob’, is limited to displaying, in the contacts directory of the smartphone, the logo corresponding to the operator of each of the contacts, with the operator being determined on the basis of the fixed and mobile indicators assigned to the operator of a country by the national telecommunications regulator.

This solution does not provide the user of the smartphone with additional information other than the identity of the operator of the contact. If the user does not know the respective prices of the operators, they will not know how to use this information.

Furthermore, the identity of the operator of the contact can be false in the case of portability of the number, i.e., if the number of the contact has been transferred from its originating operator to another operator.

The same problem exists with respect to SMSs (Short Message Service, also called text messages) sent by the subscriber. In this case, the billing unit is the SMS, for example.

One of the aims of the invention is to overcome these disadvantages of the prior art.

### 4. SUMMARY

The invention aims to improve the situation using a method for processing a request to establish a communication between a terminal, called originating terminal, and identified by at least one number, called originating number, and a terminal, called destination terminal, identified by a number, called destination number, the method being implemented in the originating terminal and comprising the following steps:
acquiring information, called pricing information, relating to pricing of the communication between the originating number and the destination number;
sending a confirmation request comprising the pricing information;
receiving a command confirming the request to establish a communication.

Unlike the prior art, according to the proposed method, when a user of a smartphone calls a number, the initiation of the call is put on hold while a confirmation is requested from the user, for example, on the screen of the smartphone. This allows the user to be notified of the pricing aspect of the call that they are about to make. The user can then decide to confirm their call or, on the contrary, to cancel it, by virtue of information relating to the pricing that will be applied to the call.

According to one aspect of the processing method, the originating and destination numbers are associated with a respective operator, and the step of sending a confirmation request is initiated when the pricing information indicates that the operator of the destination number is different from the operator of the originating number.

By virtue of this aspect, the advantages of the method are exploited as soon as the call leaves the network to which the user is subscribed, which is a situation whereby generally the calls are more expensive for the user than if they called a number on the same network.

According to one aspect of the processing method, the originating and destination numbers are associated with a respective operator, and the step of sending a confirmation request is initiated when the pricing information indicates that pricing of a communication between the operator of the destination number and the operator of the originating number is above a threshold.

By virtue of this aspect, the advantages of the method are exploited as soon as the price of the call is above a notification threshold. This threshold can be equal to zero, for example. In this way, if the user benefits, for example, from an unlimited prepaid package for all the calls to a certain operator, they are notified as soon as they attempt to call a number that is not with this operator, and which will not be free for them.

According to one aspect of the processing method, the originating terminal comprises a plurality of subscriber identity modules, called SIM (Subscriber Identity Module) cards, with the SIM cards being associated with a respective originating number, and the confirmation request further comprises an invitation to select one of the originating numbers.

By virtue of this aspect, the user can reduce the cost of a call by specifying which originating number they wish to use, i.e., which SIM card. Indeed, increasing numbers of smartphones, called multi-SIM smartphones, are equipped with a plurality of SIM cards associated with different contracts between a subscriber and an operator. Thus, the confirmation request allows a user to select the originating number that they will use for the call as a function of the pricing associated with the called number, which can be different depending on the selected SIM card.

According to one aspect of the processing method, the pricing information comprises an indication of the pricing of the communication to the destination number.

By virtue of this aspect, the user is notified of the one or more pricing rates to the called number, as a function of the calling number, in the event that they do not know these pricing rates by heart. The indication provided can simply relate to a threshold, or a comparison between several pricing rates, without these being explicitly described, which is enough for the user to decide to confirm the call in an informed manner.

According to one aspect of the processing method, the pricing information is acquired from data locally stored in the originating terminal.

By virtue of this aspect, the relevant information is available in real time. This information is not retrieved by sending a request to a remote server, which would assume a permanent connection of the smartphone to a mobile data network. The information relating to the operator of a number is present, for example, in the contacts directory stored in the smartphone, and may have been downloaded or added manually by the user during a prior phase of refining the contacts directory.

According to one aspect of the processing method, the method comprises the following steps:
sending a request to a national portability server, comprising the destination number;
receiving a response comprising an identifier of the operator of the destination number.

By virtue of this aspect, in the event that the information relating to the operator of the destination number is not stored locally, or in the event that this information is not up-to-date, for example, following a change of operator by the user of the destination number, the information is acquired using a request to a server for accessing a database of the numbers, called ported numbers. Such a server is called a number portability server, and is usually managed by a national authority regulating all operators having a license for operating mobile telecommunications services on the national territory. The request and response messages can be exchanged in real time when processing a request to establish the communication, or can be exchanged at another time, for example, when the terminal of the user is connected to a local network such as a Wi-Fi network.

According to one aspect of the processing method, the data locally stored in the originating terminal comprise a call pricing list between a plurality of operators.

By virtue of this aspect, if the contacts directory already comprises an indication of the operator for each contact, each contact does not need to be kept up-to-date with pricing information, keeping up-to-date a call pricing list between operators is sufficient. By consulting both the directory and this list, the smartphone acquires the relevant information required for the confirmation request.

This list, which includes the operators available in the zone where the smartphone of the user is located, may have been downloaded or entered manually by the user during a prior phase. The list can include, for example, pairs {originating operator; destination operator}, with the pairs being ordered in increasing order of pricing rates for a call between the first operator of the pair and the second operator of the pair. Alternatively, each pair {originating operator; destination operator} is associated with a pricing category in the form of a sign (digits, letters, etc.) indicating the pricing level between the two operators.

In the case of a multi-SIM smartphone, as soon as a destination number is selected by the user, the proposed method can therefore identify, for the operator of the destination number, the pair of operators best placed in the list and can propose the corresponding originating number to the user.

The term “communication to be established” equally covers a telephone call to be established and an SMS type message to be sent, and the various aspects described above equally apply to either case.

The various aspects of the processing method described above can be implemented independently of one another or in combination with one another.

The invention also relates to a device for processing a request to establish a communication between a terminal, called originating terminal, and identified by at least one number, called originating number, and a terminal, called destination terminal, identified by a number, called destination number, the device being implemented in the originating terminal and comprising a receiver, a transmitter, a processor and a memory coupled to the processor with instructions intended to be executed by the processor for:
acquiring information, called pricing information, relating to pricing of the communication between the originating number and the destination number;
sending a confirmation request comprising the pricing information;
receiving a command confirming the request to establish a communication.

This device, which in all the embodiments thereof is capable of implementing the processing method described above, is intended to be implemented in a mobile terminal, for example, of the smartphone type.

The invention also relates to a computer program comprising instructions which, when these instructions are executed by a processor, cause said processor to implement the steps of the processing method described above.

The invention also relates to an information medium readable by a mobile terminal, and comprising instructions of a computer program as mentioned above.

The program mentioned above can use any programming language, and can be in the form of source code, object code, or of intermediate code between source code and object code, such as in a partially compiled form, or in any other desirable form.

The aforementioned information medium can be any entity or device capable of storing the program. For example, a medium can include a storage means, such as a ROM, for example a CD-ROM or a microelectronic circuit ROM, or even a magnetic recording means.

Such a storage means can be, for example, a hard disk, a flash memory, etc. Furthermore, an information medium can be a transmissible medium such as an electrical or optical signal, which can be routed via an electrical or optical cable, by radio or by other means. A program according to the invention particularly can be downloaded over a network of the Internet type.

Alternatively, an information medium can be an integrated circuit in which a program is incorporated, with the circuit being adapted to execute or to be used to execute the method in question.

### 5. DESCRIPTION OF THE FIGURES

Further advantages and features of the invention will become more clearly apparent upon reading the following description of a particular embodiment of the invention, which is provided by way of a simple illustrative and non-limiting example, and from the accompanying drawings, among which:

FIG. 1 shows an exemplary implementation of the method for processing a request to establish a communication, according to aspects of the invention;

FIG. 2 shows an example of a structure of a device for processing a request to establish a communication, according to aspects of the invention.

### 6. DETAILED DESCRIPTION OF AT LEAST ONE EMBODIMENT OF THE INVENTION

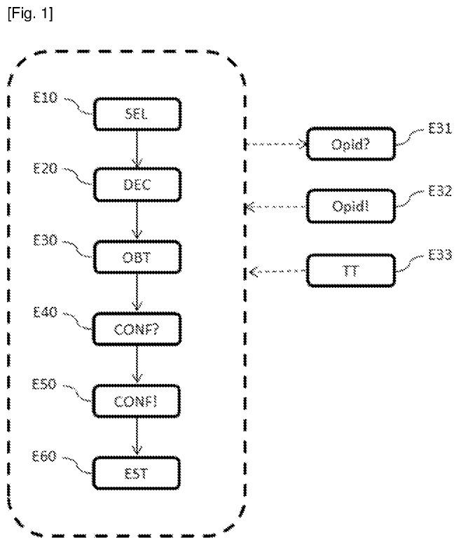

FIG. 1 shows an exemplary implementation of the method for processing a request to establish a communication, according to aspects of the invention.

During a step E10, the user selects, from the screen of their mobile terminal, a destination telephone number in the contacts directory of the terminal. The format of this number is MSISDN (Mobile Station Integrated Services Digital Network), for example, i.e., the publicly known number of a subscriber to a service of a mobile electronic communications network, more commonly called telephone number). Alternatively, the user can compose the number without using the contacts directory.

During a step E20, the user initiates the call by pressing the appropriate key, for example, by pressing on the displayed name of the contact or on the displayed number of the contact.

Alternatively, if the user wishes to send an SMS and not make a call, they press the key that initiates the opening of a message editing window.

Unlike the prior art, this initiation action executed during step E20 does not initiate establishing the communication initiated by the user during step E10, i.e., establishing a telephone call or sending an SMS, but initiates the following steps.

During a step E30, the terminal acquires information relating to the pricing of the communication between the number of the terminal and the destination number selected by the user, called pricing information.

In a first embodiment, a single SIM card is installed in the terminal, and the number of the terminal is the MSISDN number associated with the SIM card.

In a second embodiment, several SIM cards, each with an associated MSISDN number, are installed in the terminal, which is called multi-SIM terminal. In this embodiment, during step E30, the pricing information acquired by the terminal covers all the SIM cards of the terminal.

According to the invention, during step E30, the terminal can acquire the pricing information in several ways. Advantageously, this information is generated on the basis of data previously stored in the terminal of the user. Thus, the acquisition does not require a request/response to/from a pricing information server and occurs in real time when the user needs to make a call or send an SMS.

In a known manner, the terminal of the user has a contacts directory in the memory. The memory containing the directory can be specific to the terminal or can be that of a SIM card. A contact of the directory is a register comprising several fields, including the following fields:
Name: name of the contact;
Nbr: MSISDN number of the contact;
Opid: identifier of the operator responsible for the MSISDN number.

The Name and Nbr fields are usually entered by the user as they add contacts to their directory, or are entered all at once, for example, when they import a directory from an old terminal.

The Opid field can be entered in several ways. It can be entered by a mobile application previously installed in the terminal, for example, an application of the same type as the “Contacts with Morocco Operator” mobile application mentioned above. Such an application is solely based on the ranges of MSISDN numbers assigned to the operators by a national authority in order to determine the Opid field. Its disadvantage is that, in the case of portability of the number, i.e., changing operator without changing the MSISDN number, the Opid field is no longer up-to-date. The user can then update it manually, provided they know the new Opid of the number of the person in their directory, which is not necessarily the case. An alternative is the use of an improved mobile application according to the invention, which differs from that mentioned above in that it checks the value of the Opid field for the contacts of the directory with a national portability server. This check can be carried out as a whole for all the contacts, on a fairly regular basis, or on demand.

According to a particular embodiment, the terminal checks the value of the Opid field for the contact selected by the user during step E10, by consulting the national portability server. During a step E31, the terminal sends a request to this server comprising the destination number. During a step 32, it receives a response comprising the Opid of the destination number. If these optional steps E31 and E32 are carried out in real time when processing the communication requested by the user, this solution assumes that the request-response sequence is quick enough so as not to be detrimental for the user, particularly in the case of an urgent call, for example.

According to a particular embodiment, the terminal can also have, in the memory, a table TT of prices of the one or more operators, called operators of the terminal, of the one or more SIM cards of the terminal. For example, this table TT comprises, for each of the operators of the terminal, the pricing category for a communication to each of the other operators with an operating license on the same territory, and the pricing category for a communication to an operator not having such a license (for example, a foreign operator). Table 1 is an example of such a table TT:

TABLE 1
Example of a pricing table included in the terminal

| | Destination: | Destination: | Destination: | Destination: |
|---|---|---|---|---|
| | Opid = A | Opid = B | Opid = C | Opid = X |
| Opid = A | 0 | 2 | 3 | 4 |
| Opid = B | 1 | 0 | 2 | 3 |

In this example, the operators of the terminal are A and B. In other words, the terminal is a multi-SIM terminal and two SIM cards are installed therein, namely a SIM card of operator A and a SIM card of operator B. The pricing of a communication is proportional to the pricing category. Intra-operator communications, i.e., from A to A or from B to B, are governed by the pricing category 0 and are less expensive than the inter-operator communications. A communication from B to A, which is category 1, is more expensive, but less expensive than a communication from A to B, which is category 2, and so on, up to the most expensive communications, which are categories 3 and 4, which are toward X, with X denoting any foreign operator.

Such a table TT can be generated and updated in due course, during an optional step E33, for example, by using the improved mobile application according to the invention, mentioned above. This step E33 can be prior to step E10.

If necessary, two separate tables can exist, one for telephone calls and one for SMS messages.

During a step E40, the terminal sends the user a confirmation request relating to establishing the communication (call or SMS), for example, by displaying a specific message on the screen of the terminal. This specific confirmation request message includes the pricing information and includes at least two parts: a first part relating to the pricing applicable to the communication, allowing the user to make a decision, and a second interactive part, relating to the expected confirmation, allowing the user to notify the terminal of their decision. This second part is, for example, a touch zone including a button for “confirming” and a button for “canceling”.

In a first simple scenario not requiring a table TT, the terminal is a mono-SIM terminal, and the operator of the SIM card is Opid=A. The operator of the destination number is Opid=C. The terminal determines that the operators are different, and the first part of the pricing information that is displayed to the user notifies them that it is about to pass a communication to an operator different from that with which they are subscribed. The second part of the pricing information that is displayed asks them to confirm that this is indeed their intention.

In a second scenario requiring a table TT, the terminal is a multi-SIM terminal, and step E40 also comprises an invitation to select, for the communication requested during step E20, one of the SIM cards, (or one of the associated MSISDN numbers). The first part of the specific displayed message includes pricing information for each of the SIM cards, and the second part allows one of the SIM cards of the terminal to be selected, and optionally allows a choice between confirmation of a SIM card and cancellation of the procedure for establishing the communication. For example, the terminal displays a confirmation button per SIM card and a cancellation button on the touch screen.

In an example using the table TT for this second scenario, the terminal has determined, during step E30, that the operator of the current SIM card is Opid=A, and that the operator of the destination number is Opid=C. By consulting the table TT, the terminal determines that the pricing category for such a communication is 3, and that it is greater than the pricing category 2 for a communication between Opid=B and Opid=C. The first part of the pricing information that is displayed for the user notifies them that it is about to pass a communication from the operator Opid=A, which is more expensive than if it passed from the operator Opid=B of the second SIM card of the terminal. The second part of the pricing information that is displayed asks them to choose between Opid=A and Opid=B in order to pass the communication to the operator Opid=C. Optionally, the pricing information can be more detailed and also indicate the pricing categories.

The expected confirmation then can be provided by the user, during a step E50, for example, when they press in the “confirmation” zone of the touch screen, with, if applicable, the choice of a SIM card for passing the communication, or can be denied by the user when they press in the “cancellation” zone.

Finally, during a step E60, after having acquired a confirmation from the user, the terminal establishes the communication, i.e., initiates the telephone call, or opens the message editing screen in the case of an SMS.

It should be noted that in the case of an SMS, steps E30 to E60 can be executed after opening the message editing screen, once the message is composed, therefore after the user presses the “send” key of the SMS message. Step E20 then includes composing the message and pressing the send key, and it is this last action that initiates step E30 and the subsequent steps. Step E60 then does not include opening the editing screen, but does include sending the composed message.

Other embodiments allow a confirmation from the user to be dispensed with. For example, during step E40, without any action by the user at the end of a determined time period, for example, 5 seconds, the expected confirmation also can be initiated automatically, or can be denied, depending on the configuration of the terminal and optionally on the preferences of the user. In this particular embodiment, step E50 is not executed.

Alternatively, in the multi-SIM case mentioned above, where the pricing category is higher with the current SIM card than with the other SIM card of the terminal, the terminal can automatically initiate establishing the communication with the other SIM card, without requiring confirmation from the user. In this particular embodiment, the method according to the invention proceeds from step E30 directly to step E60, without executing steps E40 and E50.

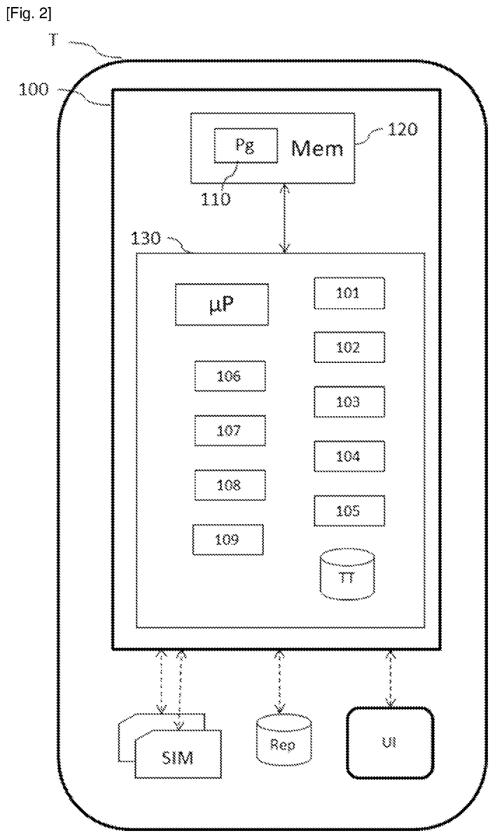

FIG. 2 shows an example of a structure of a device for processing a request to establish a communication, according to aspects of the invention.

The device 100 implements the method for processing a request to establish a communication, various embodiments of which have been described above.

Such a device 100 can be implemented in a mono-SIM or multi-SIM mobile terminal T, for example, of the smartphone type.

For example, the device 100 comprises a processing unit 130, equipped, for example, with a microprocessor μP, and controlled by a computer program 110, stored in a memory 120 and implementing the method for processing a request to establish a communication according to the invention. On initialization, the code instructions of the computer program are loaded into a RAM memory, for example, before being executed by the processor of the processing unit 130.

Such a device 100 comprises:
an acquisition module 103 capable of acquiring information, called pricing information, relating to pricing of the communication between the originating number and the destination number, from a contacts directory Rep and/or a pricing table TT;
a transmission module 104 capable of sending a confirmation request comprising the pricing information, for example, on a user interface UI of the terminal;
a reception module 105 capable of receiving a command confirming the request to establish a communication, for example, from a user interface UI of the terminal;
an establishment module 106 capable of establishing the communication requested by the user.

Advantageously, the device can further comprise:
a transmission module 107 capable of sending a request to a national portability server, comprising a telephone number;
a reception module 108 capable of receiving a response from the national portability server, comprising an identifier of the operator of the telephone number;
a reception module 109 capable of receiving an initialization or an update of the pricing table TT.

Some or all of the reception modules can be consolidated into a receiver 101. Some or all of the transmission modules can be consolidated into a transmitter 102.

Some or all of the modules 101 to 109, and the table TT, can be included in a dedicated mobile application, installed on the terminal T. This mobile application can be pre-installed by the manufacturer of the mobile device or by a mobile operator, or can be installed by the subscriber by downloading from a website, such as, for example, an AppStore. The address book Rep can be stored in one or more SIM cards, or in a memory of the mobile terminal outside a SIM card.

The modules described with reference to FIG. 2 can be hardware or software modules. FIG. 2 illustrates only one particular way, from among several possible ways, of implementing the algorithm described above with reference to FIG. 1. Indeed, the technique of the invention is equally implemented on a reprogrammable computing machine (a computer, a DSP processor or a microcontroller) executing a program comprising a sequence of instructions, or on a dedicated computing machine (for example, a set of logic gates, such as an FPGA or an ASIC, or any other hardware module). In the event that the invention is installed on a reprogrammable computing machine, the corresponding program (i.e., the sequence of instructions) may or may not be stored in a detachable storage medium (such as, for example, a USB stick, a diskette, a CD-ROM or a DVD-ROM), with this storage medium being partially or fully readable by a computer or a processor.

Although the present disclosure has been described with reference to one or more examples, workers skilled in the art will recognize that changes may be made in form and detail without departing from the scope of the disclosure and/or the appended claims.

1. A processing method comprising:
processing a request to establish a communication between an originating terminal, and identified by at least one number, called an originating number, and a destination terminal, identified by a number, called a destination number, the processing being implemented in the originating terminal and comprising:
acquiring information, called pricing information, relating to pricing of the communication between the originating number and the destination number;
sending a confirmation request comprising the pricing information; and
receiving a command confirming the request to establish a communication.

2. The processing method as claimed in claim 1, wherein the originating and destination numbers are associated with a respective operator, and wherein sending the confirmation request is initiated when the pricing information indicates that the operator of the destination number is different from the operator of the originating number.

3. The processing method as claimed in claim 1, wherein the originating and destination numbers are associated with a respective operator, and wherein of sending the confirmation request is initiated when the pricing information indicates that pricing of a communication between the operator of the destination number and the operator of the originating number is above a threshold.

4. The processing method as claimed in claim 1, wherein the originating terminal comprises a plurality of Subscriber Identity Modules, called SIM cards, with the SIM cards being associated with a respective originating numbers, and wherein the confirmation request further comprises an invitation to select one of the originating numbers.

5. The processing method as claimed in claim 1, wherein the pricing information comprises an indication of pricing of the communication to the destination number.

6. The processing method as claimed in claim 1, wherein the pricing information is acquired from data locally stored in the originating terminal.

7. The processing method as claimed in claim 6, further comprising:
sending a request to a national portability server, comprising the destination number; and
receiving a response to the request sent to the national portability server, the response comprising an identifier of an operator of the destination number.

8. The processing method as claimed in claim 6, wherein the data locally stored in the originating terminal comprise a call pricing list between a plurality of operators.

9. A device for processing a request to establish a communication between an originating terminal, and identified by at least one number, called originating number, and a destination terminal, identified by a number, called destination number, the device being implemented in the originating terminal and comprising:
a receiver,
a transmitter,
a processor, and
a memory coupled to the processor with instructions stored thereon which when executed by the processor configure the device to process the request to establish the communication by:
acquiring pricing information relating to pricing of the communication between the originating number and the destination number;
sending a confirmation request comprising the pricing information; and
receiving a command confirming the request to establish a communication.

10. (canceled)

11. A non-transitory computer readable information medium comprising instructions of a computer program stored thereon which when executed by a processor of an originating terminal configure the originating terminal to implement a method of processing a request to establish a communication between the originating terminal, which is identified by at least one number, called an originating number, and a destination terminal, identified by a number, called a destination number, the method comprising:
acquiring information, called pricing information, relating to pricing of the communication between the originating number and the destination number;
sending a confirmation request comprising the pricing information; and
receiving a command confirming the request to establish a communication.
